(19) United States
(12) Patent Application Publication
(10) Pub. No.: US 2023/0014003 A1
(43) Pub. Date: Jan. 19, 2023

(54) INTEGRATED FLUID EJECTION AND IMAGING

(71) Applicant: HEWLETT-PACKARD DEVELOPMENT COMPANY, L.P., Spring, TX (US)

(72) Inventors: Fausto D'Apuzzo, Palo Alto, CA (US); Viktor Shkolnikov, Palo Alto, CA (US); Alexander N. Govyadinov, Corvallis, OR (US)

(73) Assignee: HEWLETT-PACKARD DEVELOPMENT COMPANY, L.P., Spring, TX (US)

(21) Appl. No.: 17/778,766

(22) PCT Filed: Dec. 20, 2019
(86) PCT No.: PCT/US2019/067986

§ 371 Date: May 20, 2022

(51) Int. Cl. B41J 2/14; B41J 2/165; B41J 2/21

(52) U.S. Cl. CPC B41J 2/14153; B41J 2/16579; B41J 2/2142; G01N 21/658

(57) ABSTRACT

An integrated fluid ejection and imaging system may include a fluid ejector to eject a droplet of fluid onto a deposition site on a target, an imager to image the deposition site and a packaging supporting the fluid ejector and imager such that the fluid ejector and the imager are concurrently aimed at the deposition site on the target.

### BACKGROUND

Fluid droplets are utilized in a variety of applications such as printing, additive manufacturing, environmental testing and biomedical diagnostics. For example, such fluid droplets may comprise an ink, a binder or other similar materials with respect to printing and additive manufacturing. With respect to environmental testing and biomedical diagnostics, such fluid droplets may comprise a reactant, a stain or an analyte. In many applications, the provision of the fluid droplet is automated through the use of a fluid ejector.

### BRIEF DESCRIPTION OF THE DRAWINGS

FIG. 1 is a block diagram schematically illustrating portions of an example integrated fluid ejection and imaging system.

FIG. 2 is a flow diagram of an example integrated fluid ejection and imaging method.

FIG. 3 is a sectional view schematically illustrating portions of an example integrated fluid ejection and imaging system.

FIG. 4A is a top view of an example flat lens for the system of FIG. 3.

FIG. 4B is an enlarged view of a portion of the flat lens of FIG. 4A.

FIG. 4C is a further enlarged view a portion of the flat lens of FIG. 4B.

FIG. 5A is a top view of an example flat lens for the system of FIG. 3.

FIG. 5B is an enlarged view of a portion of the flatlands of FIG. 5A.

FIG. 6 is a sectional view schematically illustrating portions of an example integrated fluid ejection and imaging system.

FIG. 7 is a sectional view schematically illustrating portions of an example integrated fluid ejection and imaging system.

FIG. 8 is a sectional view schematically illustrating portions of an example integrated fluid ejection and imaging system.

FIG. 9 is a sectional view schematically illustrating portions of an example integrated fluid ejection and imaging system.

FIG. 10 is a sectional view schematically illustrating portions of an example integrated fluid ejection and imaging system.

FIG. 11 is a sectional view schematically illustrating portions of an example integrated fluid ejection and imaging system.

FIG. 12 is a bottom view taken along line 12-12 of FIG. 11 and illustrating one example of layout of fluid ejectors and imagers on a package.

FIG. 13 is a bottom view taken along line 12-12 of FIG. 11 and illustrating one example of layout of fluid ejectors and imagers on a package.

FIG. 14 is a flow diagram of an example method for forming an integrated fluid ejection and imaging system.

FIG. 15 is a flow diagram of an example method for forming an integrated fluid ejection and imaging system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example systems and methods that integrate fluid ejection and imaging capabilities or functions into a single unit or package. The example systems and methods integrate a fluid ejector and an imager into a single package such that the fluid ejector and the imager are concurrently aimed at a deposition site on a target that is to receive a fluid droplet. As a result, the deposition site on the target may be imaged to provide closed-loop feedback location verification for the droplet or to monitor the state of the deposition site following the addition of the droplet. For example, the deposition site may be imaged to monitor any reaction that may occur following the addition of the droplet. Because the fluid ejector and the imager are integrated into a single package by packaging that concurrently aims both the fluid ejector and the imager at the deposition site, the imaging of the deposition site may be carried out without the deposition site being moved and without time consuming alignment with an independent imager. As a result, deposition location feedback control or reaction monitoring may be carried out in much shorter amount of time or in real time.

In some implementations, the disclosed systems may provide fluid ejection and imaging capabilities in a single compact unit or package. The example systems may utilize a flat lens to focus an image of a deposition site onto an imaging array. The flat lens has a relatively small thickness while offering enhanced focusing capabilities. Example systems may partially overlap the flat lens with portions of the fluid ejector, more closely locating the imager relative to the fluid ejector and the deposition site while reducing the size of the system. In some implementations, the system may include multiple lenses, increasing in overall field-of-view for imaging and/or facilitating three-dimensional imaging of the deposition site. In some implementations, the multiple lenses of the imaging system may be located on opposite sides of the fluid ejector, further increasing the compactness of the overall package. In some implementations, the packaging that supports, partially surrounds or carries both the fluid ejector and imager additionally supports, surrounds and/or carries a target illuminator, such as a light emitting diode, also aimed at the deposition site to illuminate the deposition site during imaging. Due to their compact size, the example imaging systems may be supported at a closer distance to the target that is to receive the droplet, increasing deposition accuracy.

In some implementations, the disclosed systems facilitate easier fabrication. In some implementations, a fluid ejector and an imager may utilize a single circuitry platform, integrated circuit chip or circuit board, wherein the fluid ejection imager may be at least partially coplanar. In some implementations, lenses of the imaging system are spaced from an imaging array by transparent substrate, wherein the transparent substrate forms a fluid ejection chamber of a fluid ejector. The dual function transparent substrate reduces fabrication costs and increases the compactness of the overall package.

Disclosed is an example integrated fluid ejection and imaging system that may include a fluid ejector to eject a droplet of fluid onto a deposition site on a target, an imager to image the deposition site and a packaging supporting the fluid ejector and imager such that the fluid ejector and the imager are concurrently aimed at the deposition site on the target.

Disclosed is an example integrated fluid ejection and imaging method. The example method may include concurrently aiming a fluid ejector and an imager at a deposition site, the fluid ejector and the imager being supported by a packaging, ejecting a droplet of fluid from the fluid ejector onto the deposition site and imaging the deposition site with the imager.

Disclosed is an example method for forming an integrated fluid ejection and imaging system. The method may include forming a fluid ejector to eject a droplet of fluid, forming an imager to image the droplet of fluid and integrating the fluid ejector and the imager as part of a package such that the fluid ejector and the imager are concurrently aimed at a deposition site.

Disclosed is an example method for forming an integrated fluid ejection and imaging system. The method may include providing a circuitry platform comprising an imaging array and a fluid actuator, forming a transparent substrate on the circuitry platform over the imaging array and over the fluid actuator, forming a fluid ejection chamber opposite the fluid actuator within the transparent substrate and forming a flat lens on the transparent substrate to focus light through the transparent substrate onto the imaging array.

FIG. 1 is a block diagram schematically illustrating portions of an example integrated fluid ejection and imaging system 20. System 20 integrates a fluid ejector and an imager into a single packaging such that the fluid ejector and the imager are concurrently aimed at a deposition site on a target that is to receive a fluid droplet. As a result, the deposition site on the target may be imaged to provide closed-loop feedback location verification for the droplet or to monitor the state of the deposition site following the addition of the droplet. Imaging system 20 comprises fluid ejector 24, imager 28 and packaging 40.

Fluid ejector 24 comprises a device to selectively eject fluid droplets towards and onto a deposition site 44 on an example target 46 (shown in broken lines). In one implementation fluid ejector 24 is electrically powered and controlled through the transmission of electrical signals. In one implementation, fluid ejector 24 comprises a fluid ejection chamber that is supplied with fluid from a fluid reservoir, the fluid to be ejected by a fluid actuator that is selectively actuated to displace fluid within the chamber through an ejection orifice or nozzle opening.

In one implementation, the fluid actuator may comprise a thermal resistor which, upon receiving electrical current, heats to a temperature above the nucleation temperature of the fluid so as to vaporize a portion of the adjacent fluid to create a bubble which displaces the fluid through the associated orifice. In other implementations, the fluid actuator may comprise other forms of fluid actuators. In other implementations, the individual fluid actuators may be in the form of a piezo-membrane based actuator, an electrostatic membrane actuator, mechanical/impact driven membrane actuator, a magneto-strictive drive actuator, an electrochemical actuator, and external laser actuators (that form a bubble through boiling with a laser beam), other such microdevices, or any combination thereof.

Imager 28 comprises a device that images the deposition site 44 by capturing an image or images of the deposition site 44, before deposition of a droplet by fluid ejector 24, during deposition of the droplet by fluid ejector 24 and/or following deposition of the droplet by fluid ejector 24. In an example implementation, imager 28 may comprise a lens which focuses light or the image of the deposition site onto an imaging array. In an implementation, the lens may comprise a flat lens. Particular examples of the lens include Fresnel lenses, zone plate lenses and meta-lenses. The lens may include an amplitude mask for computational imaging. The imaging array may comprise a complementary metal-oxide-semiconductor (CMOS), a charge coupled device (CCD) sensor array or other types of imaging devices or arrays.

In the example illustrated, imager 28 is supported on a same side of the target 46 as fluid ejector 24. As a result, target 46, or any underlying support supporting target 46, may be opaque. In addition, imager 28 may be more closely spaced from the surface being imaged.

Packaging 40 integrates fluid ejector 24 and imager 28 as a single unit or package. In one implementation, packaging 40 extends along a backside of and is directly connected to fluid ejector 24 and imager 28. In an example implementation, packaging 40 partially encapsulates fluid ejector 24 and imager 28, accenting on a back sides of fluid ejector 24 and imager 28. In an example implementation, packaging 40 comprises a liquid or moldable material which is molded about portions of fluid ejector 24 and imager 28 and then solidified or hardened such as through curing or evaporation to form the single integral package.

As further shown by FIG. 1, packaging 40 supports fluid ejector 24 and imager 28 such that both fluid ejector 24 and imager 28 are concurrently aimed at deposition site 44 of the example target 46. For purposes of this disclosure, the concurrent “aiming” of a fluid ejector and imager towards a deposition site means that an individual nozzle opening of a fluid ejector extends generally opposite to the deposition site such that a droplet ejected by the fluid ejector will travel in a direction generally perpendicular to the target so as to land on the deposition site and that the field-of-view of the imager concurrently encompasses and is focused upon the deposition site without movement of the target, the fluid ejector and/or the imager relative to one another. In some implementations, the field-of-view of the imager encompasses a less than total portion of the target. In an example implementation, the field-of-view extends for a minimum of 50 microns up to 5 mm in each dimension. In some implementations, the field of view is more focused, being no less than 100 microns and no greater than 500 microns.

Because packaging 40 supports fluid ejector 24 and imager 28 such that fluid ejector 24 and imager 28 are concurrently aimed at deposition site 44, the imaging of the deposition site 44 may be carried out without the deposition site 44 being moved and without time consuming alignment with an independent imager. As a result, deposition location feedback control or reaction monitoring may be carried out in much shorter amount of time or in real time.

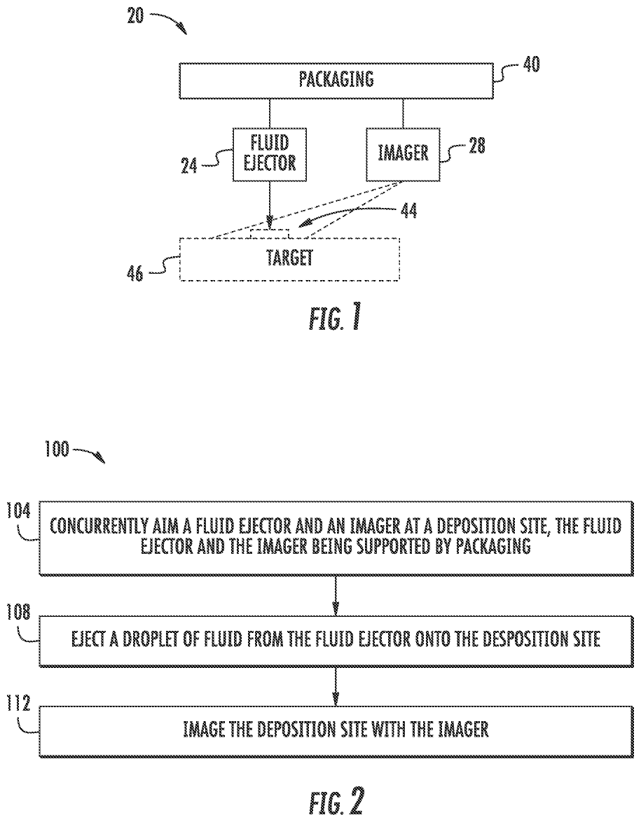

FIG. 2 is a flow diagram of an example integrated fluid ejection and imaging method 100. Method 100 facilitates imaging of a deposition site closer in time to the time at which an ejected droplet landed upon or was deposited upon the deposition site. Although method 100 is described in the context of being carried out by system 20, it should be appreciated that method 100 may likewise be carried out with any of the systems described hereafter or with other similar systems.

As indicated by block 104, fluid ejector 24 and imager 28 are concurrently aimed at a deposition site 44, wherein the fluid ejector and imager supported by a packaging 40. As indicated by block 108, a droplet of fluid is injected from the fluid ejector onto the deposition site. As indicated by block 112, the deposition site is imaged by the imager 28.

Because the fluid ejector and the imager are concurrently aimed at the deposition site, the deposition site may be immediately imaged upon landing of the droplet onto the deposition site. In other words, such imaging of the deposition site may occur without the deposition site being moved or aligned with a separate or independent imager. In some implementations, the deposition site may be imaged prior to or during landing of the droplet onto the deposition site. Method 100 facilitates deposition location feedback control or reaction monitoring in a much shorter amount of time or in real time.

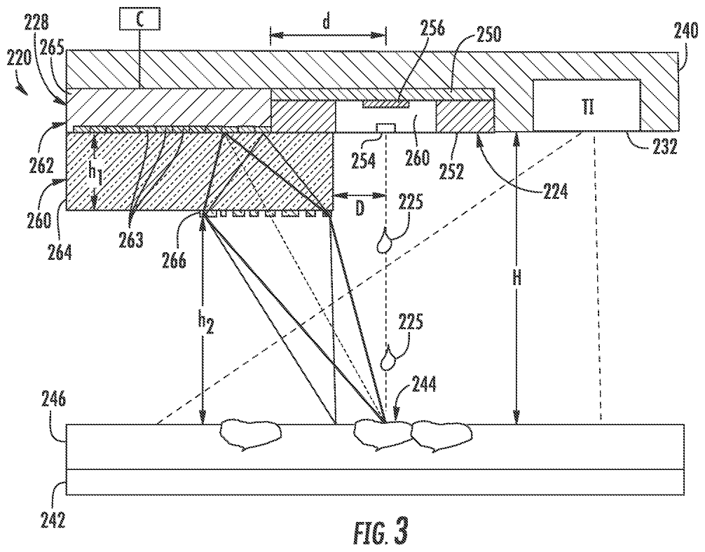

FIG. 3 is a sectional view schematically illustrating portions of an example integrated fluid ejection and imaging system 220. FIG. 3 illustrates particular examples of a fluid ejector and imager as well as a target illuminator integrated as part of a single package by packaging. FIG. 3 further illustrates how an imager may be supported so as to partially overlap fluid ejector such that system 220 is more compact. System 220 comprises fluid ejector 224, imager 228, target illuminator 232, packaging 240 and target support (TS) 242.

Fluid ejector 224 comprises a device to selectively eject a fluid droplet 225 or multiple fluid drops 225 towards and onto a deposition site 244 on an example target 246. In one implementation fluid ejector 224 is electrically powered and controlled through the transmission of electrical signals. In the example implementation, fluid ejector 224 comprises circuitry platform 250, chamber layer 252 ejection orifice 254 and fluid actuator 256.

Circuitry platform 250 comprises a structure incorporating electrically conductive wires, traces or the like and electronic components such as transistors, diodes and various logic elements. In one implementation, circuitry platform 250 comprises what is sometimes referred to as a thin-film structure. For example, circuitry platform 250 may comprise a silicon substrate that is doped to form electrically conductive transistors and upon which layers of materials are photolithographically patterned to form electrically conductive traces for powering and selectively actuating fluid actuator 256. In one implementation, circuitry platform 250 may comprise a circuit board supporting electronic componentry.

Chamber layer 250 comprises a layer or multiple layers of material supported and formed upon circuitry platform 250. Chamber layer 250 defines an internal chamber 260 which is fluidly connected to a source of fluid for being ejected through ejection orifice 254. In one implementation, chamber layer 250 may be formed from a photoresist epoxy. In one implementation, chamber layer 250 may be formed from a Bisphenol A Novolac epoxy that is dissolved in an organic solvent (gamma-butyrolactone GBL or cyclopentanone, depending on the formulation) and up to 10 wt % of mixed Triarylsulfonium/hexafluoroantimonate salt as the photoacid generator). In other implementations, chamber layer 250 may be formed from other materials such as glass, ceramics, polymers or the like.

Ejection orifice 254 comprises an opening, such as a nozzle opening, through which fluid within chamber 260 is displaced and ejected. In one implementation, ejection orifice 254 is formed by an opening extending through an orifice plate secured to chamber layer 250. In another implementation, ejection orifice 254 is formed in the material forming chamber layer 250.

Fluid actuator 256 comprises a device that, upon being actuated, displaces fluid within a fluid ejection chamber of chamber layer 26 through ejection orifice or nozzle 254. In one implementation, fluid actuator 256 comprises a thermal resistor which, upon receiving electrical current, heats to a temperature above the nucleation temperature of the fluid so as to vaporize a portion of the adjacent fluid to create a bubble which displaces the fluid through the associated orifice. In other implementations, fluid actuator 256 may comprise other forms of fluid actuators. In other implementations, fluid actuator 256 may be in the form of a piezo-membrane based actuator, an electrostatic membrane actuator, mechanical/impact driven membrane actuator, a magneto-strictive drive actuator, an electrochemical actuator, and external laser actuators (that form a bubble through boiling with a laser beam), other such microdevices, or any combination thereof.

Although fluid ejector 224 is illustrated as having a single chamber 260, a single fluid ejection orifice 254 and an associated single fluid actuator 256, in other implementations, fluid ejector 224 may comprise an array of chambers 260, orifices 254 and fluid actuators 256. For example, fluid ejector 224 may comprise columns of such orifices 254 and fluid actuators 256. In one implementation, fluid ejector 224 may comprise a sliver (having a length to width ratio of 10:1 or more) partially encapsulated or surrounded by an epoxy mold compound which forms packaging 40.

Imager 228 comprises a device carried by packaging 240 that images the deposition site 244 by capturing an image or images of the deposition site 244, before deposition of a droplet by fluid ejector 224, during deposition of the droplet by fluid ejector 224 and/or following deposition of the droplet by fluid ejector 224. In the example illustrated, imager 228 is supported on a same side of the target 246 as fluid ejector 224. As a result, target 246, or any underlying support supporting target 246, may be opaque. In addition, imager 228 may be more closely spaced from the surface being imaged. Imager 28 comprises focuser 260 and imaging array 262.

Focuser 260 comprises a lens that focuses light reflected from deposition site 244 of target 246 onto imaging array 262. In the example illustrated, focuser 260 comprises a transparent substrate 264 and a lens 266. Transparent substrate 264 comprises a layer or multiple layers sandwiched between lens 266 and imaging array 262. Transparent substrate 264 spaces lens 266 from imaging array 262 to enhance focusing of the light from deposition site 244 onto imaging array 262. In one implementation, transparent substrate 264 has a thickness of 20 microns or more. In some implementations, transparent substrate has a thickness of no greater than 2 mm. For optical performance, transparent substrate 264 may have a thickness of 100-500 microns. In one implementation, transparent substrate 264 may be formed from a transparent material such as SUB, quartz, or other transparent polymers, resists, PMMA, glass flavors. In other implementations, transparent substrate 264 may be formed from other transparent materials or may have other thicknesses. In some implementations, transparent substrate 264 may be omitted to enhance nozzle and optical surface servicing.

Lens 266 focuses the light from deposition site 244 through transparent substrate 264 and onto imaging array 262. In an implementation, the lens 266 may comprise a flat lens. In an example implementation, lens 266 comprises a flat lens having a thickness of 1 μm or less, facilitating a short working distance of less than 2 mm without difficult alignment given its flat form. Particular examples of the lens 266 include Fresnel lenses, zone plate lenses and meta-lenses. The lens may include an amplitude mask for computational imaging.

FIGS. 4A, 4B and 4C illustrate lens 366, an example of lens 266. Lens 366 comprises a flat lens in the form of a meta lens. In an example implementation, lens 366 has a phase distribution that is sampled approximately every 50 to 300 nm in x,y with a phase resolution of π/7 or less for diffraction-limited performance. As a result, focusing efficiency may be as high as 80% to 90%, but may involve the fabrication of features having a size in a range of 50 to 100 nm. In the example illustrated, the phase sampling is provided with pillars 368 (shown in FIG. 4C), also referred to as resonators, of different diameters having the illustrated distribution. In the example illustrated, the distribution of pillars 368 has a phase profile having a continuous smooth function of x,y except for zone boundaries where the phase is folded in 2 π to facilitate ease of fabrication. In one implementation, the pillars comprise cylindrical nano-resonators with a hexagonal configuration (five pillars equally spaced about a center pillar), the individual pillars having a height of 400 nm, a center to center spacing of 325 nm and the outer pillars 368 having an angular offset of 60°. In one implementation, the pillars may be formed from a transparent material such as TiO₂. In other implementations, the pillars shown in FIG. 4C may be formed from other material such as amorphous silicon or transparent polymers. The meta lens provides a high refractive index (anything above n=1.5 to n=3 and above depending on wavelength), a low absorbency at a working wavelength range (transmission better than 70%, including absorption and scattering losses), and low roughness (at least λ/4 and in some implementations, λ/14 or to λ/100, wherein λ is the wavelength). In some implementations, the meta-lenses may be made from metallic nanostructures, which have significantly more losses, but might be easier to fabricate. The meta-lenses (both metallic and dielectric) may also be made of nanostructures other than pillars. Such pillars may be any shape such as square pillars, polyhedrons, v-shaped polyhedrons, and other topological deformations, coupled resonators, and so on.

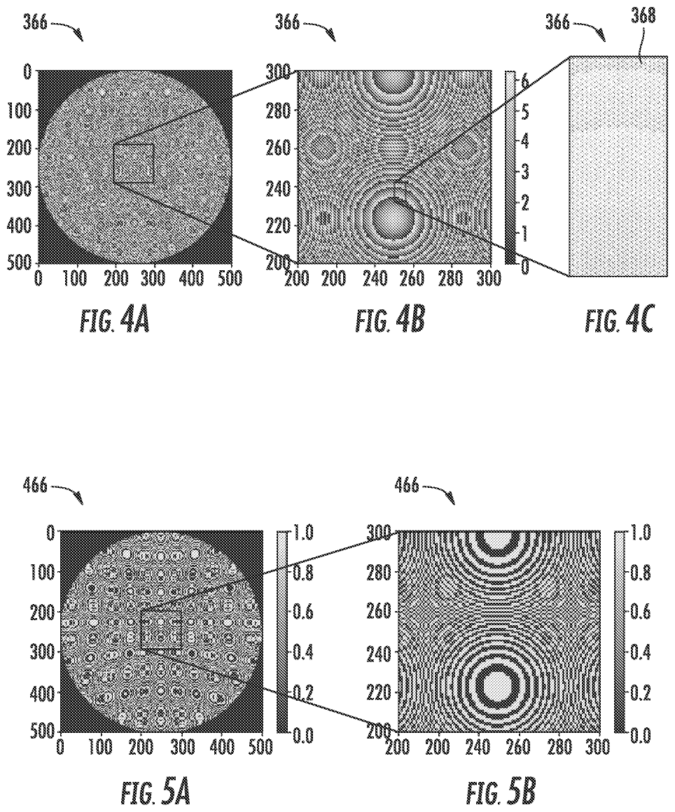

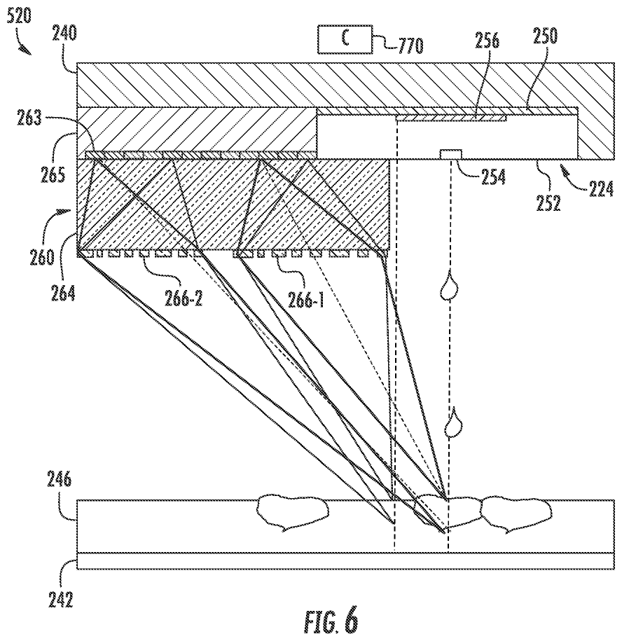

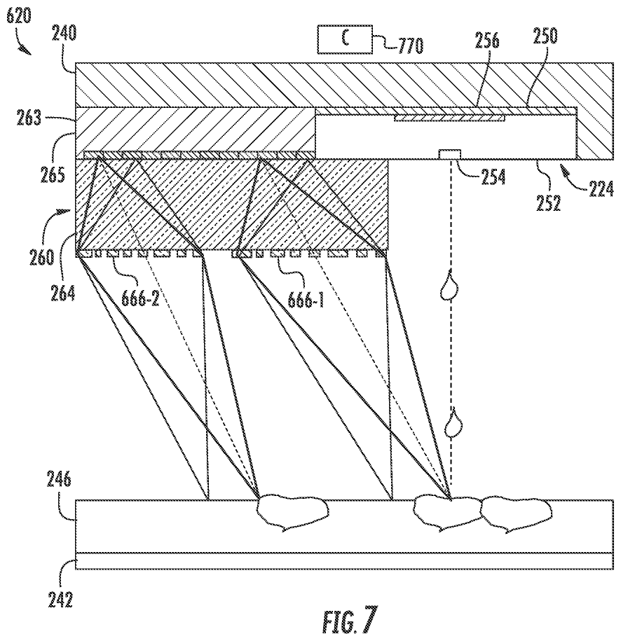

FIGS. 5A and 5B illustrate lens 466, another example of lens 266. Lens 466 comprises a flat lens in the form of a zone plate. Lens 466 is phase sampled at a few discrete levels. In one implementation, the zone plate of lens 466 is sampled at two levels (0, π) or up to π/4 increments. As a result, fabrication is easier due to the larger minimum feature size. In contrast to a meta lens, lens efficiency may be below 40% transmission efficiency. However, the zone plate may be fabricated with e-beam lithography out of low absorbency material such as Polydimethylsiloxane (PDMS), also sometimes referred to as dimethylpolysiloxane or dimethicone.

As further shown by FIG. 3, focuser 260 overlaps portions of fluid ejector 224. Portions of both transparent substrate 264 and lens 266 overlap portions of fluid ejector 224. Portions of transparent substrate 264 are sandwiched between lens 266 and fluid ejector 224. As a result, lens 266 may be supported more closely to ejection orifice 254 and deposition site 244 for enhanced imaging of deposition site 244. In other implementations, this overlap may be omitted.

Imaging array 228 is supported by packaging 240. Imaging array 228 comprises an array of individual optical or light sensing elements 263 supported by an electronics platform 265. The individual optical light sensing elements 263 receive light focused by lens 266 through substrate 264 and outputs electrical signals based upon the received light. Imaging array 228 may comprise a complementary metal-oxide-semiconductor (CMOS), a charge coupled device (CCD) sensor array or other types of imaging elements. The electronics platform 265 ports electrically conductive traces, transistors and other electronic componentry for powering and operating light sensing elements 263. In one implementation, elements 263 and electronic platform 265 may comprise a thin film, a circuit board, a die or other unitary structure.

Target illuminator 232 comprises an electronic component that illuminates portions of target 246 with light that may be reflected from deposition site 244 and that may be received by focuser 260. In an example implementation, target illuminator 232 may comprise a light emitting diode. In an example implementation, target illuminator 232 may comprise a laser diode for monochromatic imaging to reduce the effect of chromatic aberrations off-axis of the optical system. In other implementations, target illuminator 232 may comprise other light-emitting devices. In the example illustrated, target illuminator 232 is supported by packaging 240. In the example illustrated, target illuminator 232 is encapsulated by packaging 240. In other implementations, target illuminator 232 may be surface mounted upon the overall package of system 220, such as upon a die forming system 220. In other implementations, target illuminator 232 may be separate and distinct from packaging 240 and from a die forming system 220. In some implementations, such as where ambient light is sufficient, target illuminator 232 may be omitted.

Packaging 240 integrates fluid ejector 224 and imager 228 as a single unit or package. In the example illustrated, packaging 240 supports imaging array 228 so as to be coplanar with fluid ejector 224, alongside fluid ejector 224. In the example illustrated, packaging 240 extends along a backside and is directly connected to fluid ejector 224 and imager 228. In the example illustrated, packaging 240 partially encapsulates fluid ejector 224 and imager 228, extending on back sides of fluid ejector 224 and imager 228 and about sides of fluid ejector 224 and/or imager 228.

In the example illustrated, packaging 240 additionally encapsulates target illuminator 232, wherein target illuminator 232 is supported on an opposite side of fluid ejector 224 as imager 228. In the example illustrated, target illuminator 232, fluid ejector 224 and imager 228 are all concurrently aimed at the deposition site 244 such that a droplet of fluid may be ejected onto deposition site 244, may be illuminated by target illuminator 232 and may be imaged by imager 228 without relative movement of target 246 or imaging system 220. In an example implementation, packaging 240 comprises a liquid or moldable material which is molded about portions of fluid ejector 224 and imager 228 and then solidified or hardened such as through curing or evaporation to form the single integral package.

As further shown by FIG. 3, packaging 240 supports fluid ejector 224 and imager 228 such that both fluid ejector 224 and imager 228 are concurrently aimed at deposition site 244 of the example target 246. In some implementations, the field-of-view of the imager encompasses a less than total portion of the target. In an example implementation, the field-of-view extends for a minimum of 50 microns up to 5 mm in each dimension. In some implementations, the field of view is more focused, being no less than 100 microns and no greater than 500 microns.

Target support 242 supports target 246 and deposition site 244 generally opposite to fluid ejector 224 and imager 228. In one implementation, target support 242 may comprise an X-Y movable platform for selectively positioning different deposition sites opposite to fluid ejector 224 and imager 228. In one implementation, target support 242 supports target 246 such that deposition site 244 is spaced from fluid ejection orifice 254 by no greater than 10 mm. Although target support 242 may be used for selectively positioning different deposition sites for receiving droplets 225 from fluid ejector 224 and for concurrently being imaged by imager 228, because packaging 240 supports fluid ejector 224 and imager 228 such that fluid ejector 224 and imager 228 are concurrently aimed at deposition site 244, the imaging of the deposition site 244 may be carried out without the deposition site 244 being moved and without time consuming alignment with an independent imager. As a result, deposition location feedback control or reaction monitoring may be carried out in much shorter amount of time or in real time.

In some implementations, target support 242 may be omitted. For example, in some implementations, the target 246 may comprise a living organism capable of autonomous movement or a manually movable target. In such circumstances, imager 228 may be used to capture images of target 246 as target 246 is moved relative to fluid ejector 228. In such an application, images captured by imager 228 may be used to precisely align a particular deposition site on target 246 with fluid ejector 224 so as to facilitate precise locational accuracy for the deposition of a droplet to 250 droplets 225 onto target 246. Because imager 228 and fluid ejector 224 are concurrently aimed at the same spot or location, fluid ejector 224 may be actuated to eject a droplet 225 immediately, in real time, in response to imager 228 capturing images indicating that target 246 is in position such that the targeted deposition site 244 will receive any droplet 225 ejected by fluid ejector 224.

In some implementations, the immediate or real time imaging of target 246 and the concurrent aiming of imager 228 and fluid ejector 224 at the same spot may facilitate precise locational control over landing site of ejected fluid droplets during continuous uninterrupted movement of target 246. For example, in some implementations, multiple images captured by imager 228 may be transmitted to and used by a controller 270 (comprising from a processor and a computer-readable medium such as schematically shown in FIG. 8) to control the time at which droplets 225 are ejected. In an example implementation, the controller may use images from imager 228 to identify when ejection orifice 254 is precisely located over a target deposition site 244 (during movement of target 246) and immediately actuate fluid ejector 224 at such time. In another example implementation, the controller may use images from imager 228 to determine the current speed and direction of movement of target 246. Using the determined speed and direction of target 246, the spacing between orifice 254 and the surface of target 246 and the velocity of an ejected droplet, controller 270 may preemptively (before the target deposition site is actually opposite to ejection orifice 254) output signals actuating fluid ejector 224 such that droplet 225 will be ejected at a determined point in time such that droplet 225 will land on the target deposition site during the movement of target 246. This may be especially beneficial in circumstances where the target 246 is a living organism subject to movement or shaking or where target 246 is being manually positioned and may be undergoing shaking her movement.

In an example implementation, system 220 has the following geometric characteristics. The spacing d between the ejection orifice and the edge of the imager 228 is between 50 microns and 5 mm, and nominally 0.5 mm. The printing distance H is between 100 microns and 5 mm, and nominally 2 mm. The magnification M provided by the imaging array 262 is between 0.05× and 20×, and nominally 0.3×. The field-of-view F of imager 228 is between 50 microns and 5 mm, and nominally 0.4 mm. The transparent substrate 264 has a thickness h1 of MH/(1+M), a thickness of between 20 microns and 3 mm, and nominally 0.4 mm. The working distance h2 between lens 266 and target 246 is H-h1, between 100 microns and 5 mm, and nominally 1.54 mm. The orifice to substrate edge distance D (fluidically constrained) is between 50 microns and 3 mm, and nominally 0.2 mm. In other implementations, system 220 may have other geometric characteristics which may vary depending upon the characteristics of fluid ejector 224, target 246, imaging array 262 and lens 266.

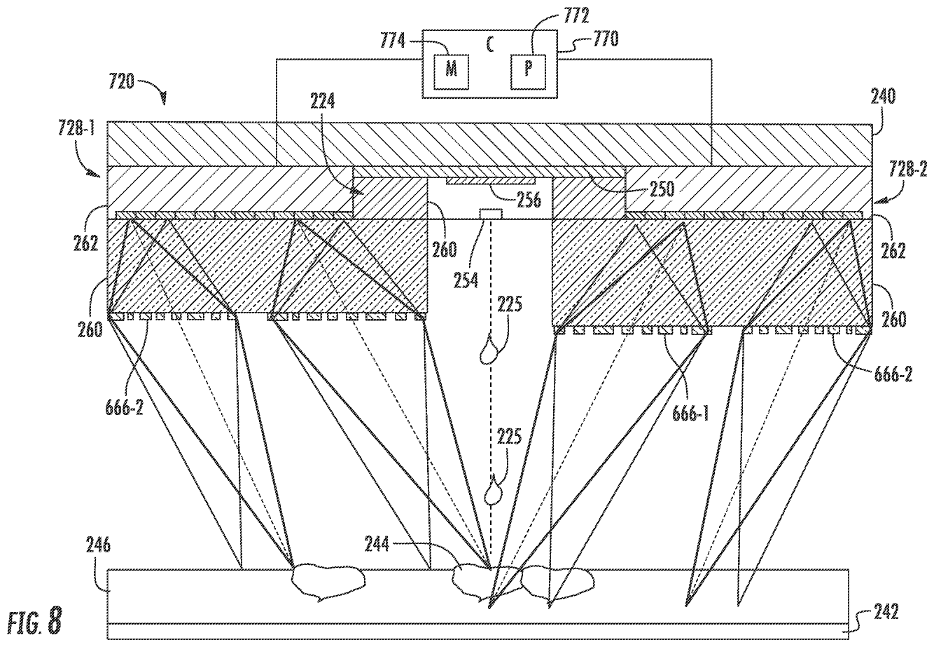

FIG. 6 is a sectional view schematically illustrating portions of an example integrated fluid ejection and imaging system 520. FIG. 6 illustrates the provision of multiple lenses 266-1, 266-2 (collectively referred to as lenses 266), such as multiple flat lenses, upon substrate 264. The remaining components of system 520 which correspond to components of system 220 are numbered similarly and/or are shown in FIG. 3. For example, although not specifically shown, system 520 may additionally include target illuminator 232 as described above. Lenses 266 extend on one side of fluid ejector 224. Each of lenses 266 is concurrently focused upon deposition site 244. Due to the different positioning, lenses 266 have different focal planes.

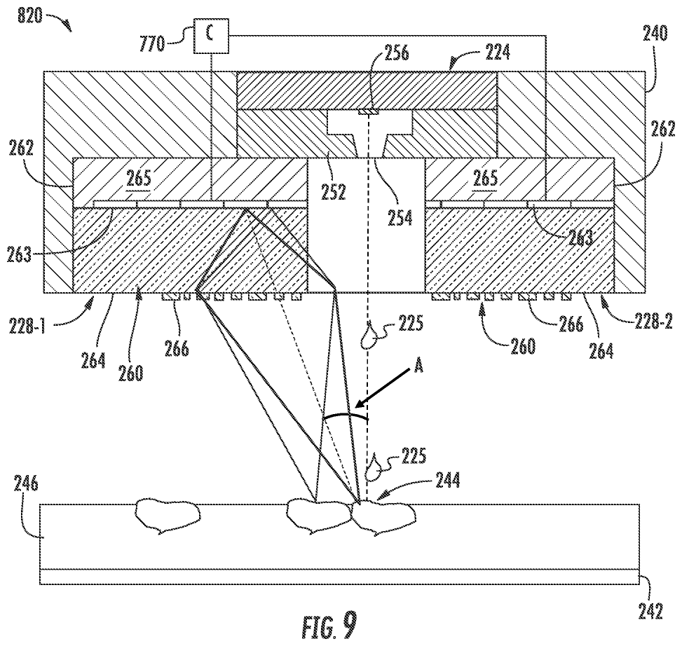

FIG. 7 is a sectional view schematically illustrating portions of an example integrated fluid ejection and imaging system 620. FIG. 7 illustrates the provision of multiple lenses 666-1, 666-2 (collectively referred to as lenses 666), such as multiple flat lenses, upon substrate 264. The remaining components of system 620 which correspond to components of system 220 are numbered similarly and/or are shown in FIG. 3. For example, system 620 may additionally include target illuminator 232 as described above. Lenses 666 extend on one side of fluid ejector 224. Lenses 666 provide system 620 with an enlarged total field-of-view as compared to system 220.

FIG. 8 is a sectional view schematically illustrating portions of an example integrated fluid ejection and imaging system 720. FIG. 8 illustrates the provision of multiple imagers 728-1, 728-2 (collectively referred to as imager 728) on opposite sides of fluid ejector 224. The remaining component of system 720 which correspond to components of system 220 are numbered similarly and/or are shown in FIG. 3. For example, system 720 may additionally include target illuminator 232 as described above.

Imagers 728 are each similar to the imager shown in FIG. 7. Each of imagers 728 includes multiple lenses 666-1, 661-2 supported by transparent substrate 264. In addition to providing system 720 with a larger field-of-view and with imaging have different focal planes, because imagers 728 are located on opposite sides of fluid ejector 224, imagers 728 may capture or collect two different perspectives of deposition site 244. In some implementations, the different images captured at different perspectives may be used by a controller 770 to combine the images to provide for stereo vision and/or provide three-dimensional imaging or other information for fluid droplet or droplets at the deposition site 244. In the example illustrated, controller 770 comprises a processor 772 that follows instructions contained in a computer-readable medium 774 to combine the captured images taken from different perspectives by the different imagers 728 to output stereo vision or three-dimensional information regarding the droplets or any changes at deposition site 244. In some implementations, controller 770 may also function similar to controller 270 described above, controlling the timing of fluid ejection when target 246 may be moving.

FIG. 9 is a sectional view schematically illustrating portions of an example integrated fluid ejection and imaging system 820. FIG. 9 illustrates the stacking of multiple imagers 228-1, 228-2 (collectively referred to as imagers 228) relative to fluid ejector 224 and on opposite sides of fluid ejector 224. The remaining component of system 820 which correspond to components of system 220 are numbered similarly and/or are shown in FIG. 3. For example, system 820 may additionally include target illuminator 232 as described above.

Each of imagers 228 is similar to imager 228 described above with respect to system 220 except that imagers 228-1 and 228-2 are each stacked so as to overlap fluid ejector 224. Both focuser 260 and imaging array 262 overlap portions of fluid ejector 224. Substrate 264 and portions of imaging array 262 are sandwiched between lens 266 and portions of chamber layer 252 of fluid ejector 224. In the example illustrated, fluid ejector 224 ejects droplets 225 along an ejection trajectory or path that extends between imagers 228-1 and 228-2. Because imagers 228 overlap portions of fluid ejector 224, the overall size of the package of system 820 is reduced. In addition, the off-axis angle A is reduced to improve image quality and aberration control while avoiding interference with fluid trajectory.

As described above with respect to system 720, in an example implementation, both of imagers 228 may be focused on the same deposition site 244. As a result, the deposition site 244 may also be captured or observed by imagers 228 from multiple perspectives. The multiple different captured images taken at the different perspectives may be combined by controller 770 to output stereo vision or three-dimensional information regarding the droplets or any changes at deposition site 244.

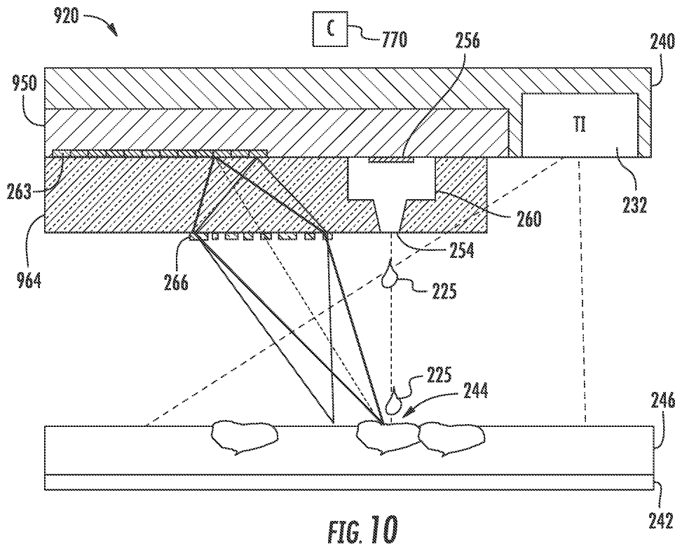

FIG. 10 is a sectional view schematically illustrating portions of an example integrated fluid ejection and imaging system 920. FIG. 10 illustrates a further degree of integration as between a fluid ejector and an imager. Those portions of system 920 which correspond to portions of system 220 are numbered similarly.

As shown by FIG. 10, the same circuitry platform that supports fluid actuator 256 and its associated electronic components (electrically conductive traces and transistors) also supports and carries the imaging array and its associated electronic components. The same transparent substrate that supports lens 266 and through which light is focused by length 266 onto the imaging array also forms the chamber layer for the fluid ejector. As a result, system 920 is more compact and may be less complex or less costly to fabricate. System 920 comprises circuitry platform 950, fluid actuator 256, transparent substrate 964, lens 266 and imaging array 262. In the example illustrated, portions of circuitry platform 950 and portions of transparent substrate 964 along with fluid actuator 256 form a fluid ejector. Portions of circuitry platform 950 and portions of transparent substrate 964 further form portions of an imager.

Circuitry platform 950 includes electrically conductive traces, transistors and other electronic componentry for powering and controlling both fluid actuator 256 (described above) and the optical or light sensing elements 263 (described above). Circuitry platform 950 may additionally comprise electrically conductive traces for transmitting electrical signals. Circuitry platform 950 may be in the form of a thin film, a circuit board or a single electronic die.

Transparent substrate 964 is similar to transparent substrate 264 described above except that transparent substrate 964 further extends below and across fluid actuator 256 while serving as a chamber layer that also provides fluid ejection chamber 260 (described above). In one implementation, transparent substrate 964 is formed from SUB. In other implementations, transparent substrate 964 may be formed from other materials such as quartz, glass, polymers and the like. In an example implementation, transparent substrate 964 additionally forms ejection orifice 254 (described above). In another example implementation, a separate orifice plate is mounted over portions of substrate 964 to form ejection orifice 254. As with transparent substrate 264, transparent substrate 964 supports lens 266, wherein lens 266 focuses light through transparent substrate 964 and onto the array of sensing elements 263.

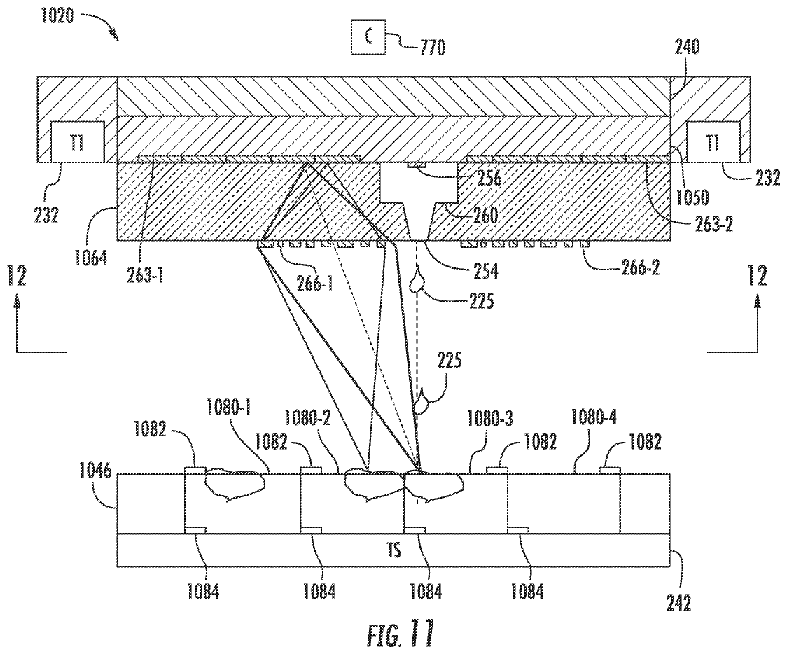

FIG. 11 is a sectional view schematically illustrating portions of an example integrated fluid ejection and imaging system 1020. System 1020 is similar to system 920 described above except that system 1020 integrates two imagers with each fluid ejector and comprises a target 1046 in the form of a well plate. The remaining components of system 1020 which correspond to components of system 920 are numbered similarly.

System 1020 comprises circuitry platform 1050 and transparent substrate 1064 in place of circuitry platform 950 and transparent substrate 964, respectively. System 1020 comprises two arrays of imaging elements 263-1 and 263-2 in place of imaging elements 263. System 1020 comprises two lenses 266-1 and 266-2 (collectively referred to as lenses 266) in place of lens 266. Circuitry platform 1050 is similar to circuitry platform 950 except that circuitry platform 1050 of system 1020 supports imaging arrays 263-1 and 263-2 (collectively referred to as arrays 263) on opposite sides of fluid actuator 256. Circuitry platform 1050 includes electrically conductive wires or traces for transmitting signals between controller 770 (described above) and arrays 263. Circuitry platform 1050 further comprises transistors and other electronic componentry for powering and actuating arrays 263.

Transparent substrate 1064 is similar to transparent substrate 964 except that transparent substrate 1064 supports lenses 266 on opposite sides of ejection orifice 254. Lenses 26 are each similar to lens 266 described above. Lenses 266-1 and 266-2 focus light from target 1046 onto their respective imaging arrays 263-1 and 263-2. In an example implementation, lenses 266 are each focused on the same deposition site to provide different perspectives of the deposition site, facilitating the construction of stereoscopic or three-dimensional images of the deposition site. In another example implementation, lenses 266 are focused on different portions of target 1046, providing a wider field of view and, in some implementations, facilitating imaging of multiple wells of the well plate.

In the example illustrated, system 1020 additionally comprises two target illuminators 232. In the example illustrated, one of the target illuminators 232 is supported by packaging 240 while the other of target illuminators 232 is supported independent of packaging 240. The two target illuminators 232 provide illumination of the target 1046 for each of the two different imagers formed by the two pairs of lenses 266 and imaging arrays 263. Although the sectional view illustrates imaging arrays 263 and lenses 266 as extending on opposite sides of orifice 254, it should be appreciated that in some implementations, imaging arrays 263 and lenses 266 may be in the form of (a) a single imaging array and a single continuous lens or (B) multiple imaging arrays and/or multiple lenses that collectively surround or encircle ejection orifice 254, providing a larger field of view or providing additional perspectives for the construction of a stereoscopic or 3D image of a deposition site.

In the examples illustrated, both a circuitry platform and a transparent substrate are shared by both an imager and a fluid ejector. In other implementations, the imager and the fluid ejector may share the circuitry platform, wherein the imager has a dedicated transparent substrate 964, 1064 while the fluid ejector has a dedicated chamber layer 252. In other implementations, the imager and the fluid ejector may have distinct dedicated circuitry platforms 250 and 265, wherein the transparent substrate 964, 1060 used by the imager also forms the fluid ejection chamber 260.

Target 1046 is in the form of a well plate comprising multiple individual wells 1080-1, 1080-2, 1080-31080-4 and so on (collectively referred to as wells 1080. Each of wells 1080 comprises a volume to receive a solution or material as well as to receive droplets 225 ejected through orifice 254. Each of wells 1080 may include registration markings 1082 (schematically shown) rather than a transparent finishing. Such registration markings 1082 may facilitate identification of individual wells by the imagers of system 1020. In some implementations, the registration markings 1082 may comprise well-off lines or fiducial marks (crosses, posts and the like) imprinted, embossed, laser engraved or scribed into the wells 1082. Each of wells 1082 may additionally or alternatively include landing pads 1084 (schematically shown) for registration with respect to wells 1080 and/or ejection orifice 254.

In an example implementation, each of wells 1080 comprises a micro-reaction micro well having a cross-sectional area on a scale of less than one mm². Because ejection orifice 254 and one or both of the imagers formed by lenses 266-1, 266-2 are aimed or focused on the same location or spot, providing built-in alignment of ejection orifice 254 with the concurrently imaged deposition site (the interior of a well), the individual wells 1080 may be precisely located for both imaging and the reception of a fluid droplet or multiple droplets. As a result, the wells 1080 may have smaller cross-sections and the array may have a greater density of wells. Real-time monitoring of the placement of droplets or real-time monitoring of the positioning of wells 1080 is facilitated to facilitate faster sample processing and analysis.

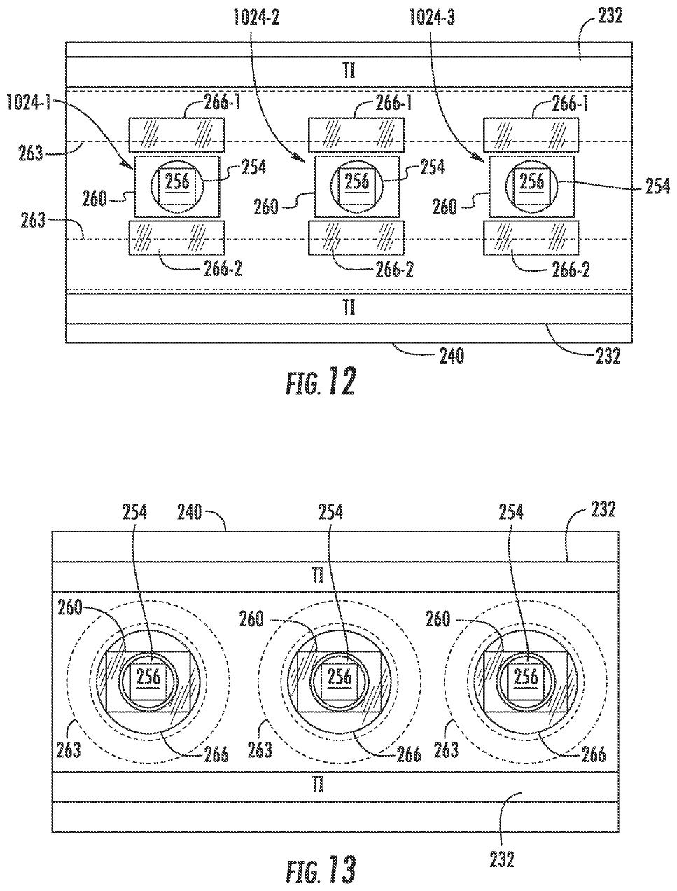

FIG. 12 is a bottom view of a portion of one implementation of system 1020 taken along line 12-12 of FIG. 11. FIG. 12 illustrates one example of how the fluid ejectors and imagers of system 1020 may be arranged or laid out on a single integrated packaging, such as a single integrated die. In the example illustrated, the fluid ejectors 1024-1, 1024-2 and 1024-3 (collectively referred to as ejectors 1024), formed by fluid ejection orifices 254, fluid actuator 256 and ejection chambers 260, are arranged in rows or columns along packaging 240. In the example illustrated, each of fluid ejectors 1024 has its own opposite dedicated pair of lenses 266. In the example illustrated, imaging elements 263 are formed as a single continuous band or strip of elements extending along the row or column of fluid ejectors 1024. Distinct portions of the continuous band or strip of elements 263 may be associated with distinct fluid ejectors 1024. In the example illustrated, target illuminators 232 are also provided as a single continuous row or column of light emitters, such as light emitting diodes. In other implementations, each of fluid ejectors 1024 may have an associated pair of imaging array elements 263 and/or target illuminators 232.

FIG. 13 is a bottom view of a portion of one implementation of system 1020 taken along line 12-12 of FIG. 11. FIG. 13 illustrates one example of how the fluid ejectors and imagers of system 1020 may be arranged or laid out on a single integrated packaging, such as a single integrated die. As with the example illustrated in FIG. 12, in the example in FIG. 13, the fluid ejectors 1024, formed by fluid ejection orifices 254, fluid actuator 256 and ejection chambers 260, are arranged in rows or columns along packaging 240. In the example illustrated, each of fluid ejectors 1024 has its own dedicated pair of lenses 266. In the example of FIG. 13, however, each of fluid ejectors 1024 has a lens or a group of lenses 266 that surround or encircle ejection orifice 254. Likewise, each of fluid ejectors 1024 has imaging array elements 263 that collectively surround or encircle ejection orifice 254, providing a larger field of view or providing additional perspectives for the construction of a stereoscopic or 3D images of a deposition site. Although elements 263 and lenses 266 are illustrated as continuously encircling their respective fluid ejection orifices 254, in some implementations, elements 263 and/or lenses 266 may be arranged in individual distinct groupings or clusters of elements or distinct groupings or clusters of lenses spaced around and about their respective fluid ejection orifices 254.

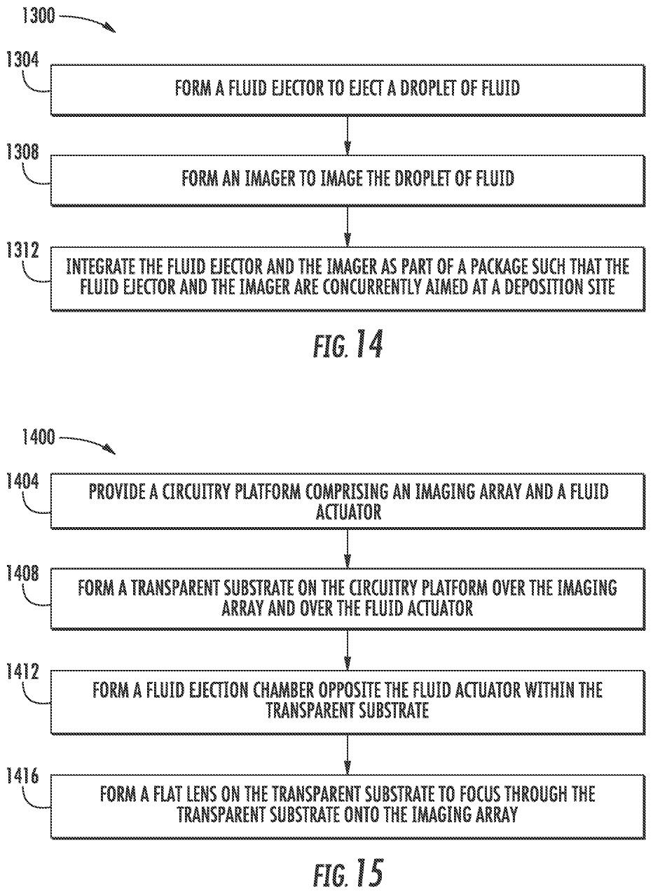

As mentioned above, the above described integrated fluid ejection and imaging systems may facilitate less complex and lower cost fabrication. FIG. 14 is a flow diagram of an example method 1300 for forming such an integrated fluid ejection and imaging system. Method 1300 may be utilized to form portions of any of the above described systems.

As indicate by block 1304, a fluid ejector is formed to eject a droplet of fluid. As indicated by block 1308, an imager is formed to image the droplet of fluid, such as after the droplet of fluid has landed onto a target deposition site. As indicated by block 1312, the fluid ejector and the imager are integrated as part of a package, such as with packaging 40 described above, such that the fluid ejector and the imager are concurrently aimed at a deposition site. As illustrated above, the integration of the fluid ejector and the imager by packaging 40 or 240 may be achieved by encapsulating or partially encapsulating the formed imager and the fluid ejector by a liquid or moldable material, which when dried and/or cured, hardens or solidifies to support and carry both the fluid ejector and the imager as part of a single unit or package. Because the fluid ejector and the imager are supported so as to be concurrently aimed at a same location, spot or deposition site, the imaging of the deposition site may be carried out without the deposition site being moved and without time consuming alignment with an independent imager. As a result, deposition location feedback control or reaction monitoring may be carried out in much shorter amount of time or in real time.

In some implementations, images captured by the imager may be used to precisely align a particular deposition site on a target with the fluid ejector so as to facilitate precise locational accuracy for the deposition of a droplet or droplets onto the target. Because the imager and the fluid ejector are concurrently aimed at the same spot or location, the fluid ejector may be actuated to eject a droplet immediately, in real time, in response to imager capturing images indicating that the target is in position such that the targeted deposition site will receive any droplet ejected by the fluid ejector.

FIG. 15 is a flow diagram of an example method 1400 that may be used to form an example integrated fluid ejection and imaging system, such as system 920 or system 1020, wherein portions of the system are functionally shared by both the imager and the fluid ejector. As indicated by block 1404, a circuitry platform is provided, wherein the circuitry platform comprises an array of imaging elements and a fluid actuator. As indicated by block 1408, the transparent substrate is formed on the circuitry, over the imaging array and over the fluid actuator. As indicated by block 1412, a fluid ejection chamber is formed within the transparent substrate opposite the fluid actuator. As indicated by block 1416, a flat lens is formed on the transparent substrate to focus through the transparent substrate onto the imaging array.

Each of the above-described integrated fluid ejection and imaging systems facilitate real-time monitoring pertaining to the placement of fluid droplets to allow for precision dispensing on arbitrarily determined targets. Such real-time monitoring may be beneficial in the precision staining of small regions of tissues with real-time feedback for further staining. Such systems may facilitate the interrogation of a tissue with a large number of stains and therefore obtaining a large amount of information from a small amount of tissue.

Each of the above-described integrated fluid ejection and imaging systems may be used in various applications such as A/B testing in precious samples such as pathobiology slides, samples from tissue banks, cancer and other biopsies as well as in situ multiplex staining, drug delivery and transfection in pathology slides, tissue bank samples, cancer and other biopsies. The above-described integrated fluid ejection imaging systems may further be used to identify anti-microbiology susceptibility testing for slow-growing bacteria colonies in petri dishes and the mechanical probing of adherent single cells by monitoring structural responses of the cytoskeleton to droplet impact. The integrated fluid ejection images of may also be used to carry out scientific research and material science with respect to metallurgy or nano materials, to carry out imaging and research with regard to non-flat substrates such as the patient's skin, to carry out precision assembly of soft structures such as 3D printing tissues and the labeling of microscopic “moving” agents such as insects or micro-bots.

In one implementation, multiple stains are ejected by a fluid ejector onto nearby regions, probing a small amount of tissue with a large number of stains. In some implementations, surface enhanced Raman scattering (SERS) sensors may carry out quantitative analysis of chemical concentrations for stained regions as small as 50 μm in diameter using packages having fluid ejection orifices 254 with diameters of 20 μm or less. Such systems may monitor the response of tissue to staining and thereafter staining subsequent regions based on information from previous regions. The ability to stain new regions based on information from previous regions may significantly reduce the use of tissue, which may be especially advantageous for pressure samples such as bio banks tissues and rare disease tissues.

Although the present disclosure has been described with reference to example implementations, workers skilled in the art will recognize that changes may be made in form and detail without departing from the disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. An integrated fluid ejection and imaging system comprising:
a fluid ejector to eject a droplet of fluid onto a deposition site on a target;
an imager to image the deposition site; and
a packaging supporting the fluid ejector and imager such that the fluid ejector and the imager are concurrently aimed at the deposition site on the target.

2. The system of claim 1, wherein the imager comprises:
an imaging array; and
a focuser to focus the deposition site onto the imaging array.

3. The system of claim 2, wherein the focuser comprises:
a flat lens; and
a transparent substrate sandwiched between the flat lens and the imaging array.

4. The system of claim 3, the fluid ejector comprises:
a circuitry platform comprising a fluid actuator; and
a fluid ejection chamber, the fluid ejection chamber being formed within the transparent substrate.

5. The system of claim 4, wherein the fluid ejector further comprises a fluid ejection orifice and wherein the imaging array and the flat lens are on a first side of the fluid ejection orifice, the system further comprising:
a second image array supported by the package; and
a second flat lens supported by the package, wherein the transparent substrate is sandwiched between the second flat lens and the second image array and wherein the second image array and the second flat lens accent on a second side of the fluid ejection orifice.

6. The system of claim 5 further comprising a controller to combine the first image output by the imaging array and a second image output by the second imaging array.

7. The system of claim 4, wherein the circuitry platform comprises the imaging array.

8. The system of claim 3, wherein the fluid ejector comprises a fluid ejection orifice and wherein the imaging array and the flat lens are on a first side of the fluid ejection orifice, the system further comprising:
a second image array supported by the package; and
a second flat lens supported by the package, wherein the transparent substrate is sandwiched between the second flat lens and the second image array and wherein the second image array and the second flat lens are on a second side of the fluid ejection orifice.

9. The system of claim 8, wherein the fluid ejector comprises:
a circuitry platform comprising a fluid actuator; and
a chamber layer forming a fluid ejection chamber adjacent the fluid actuator; and
a fluid ejection orifice extending from the fluid ejection chamber to direct the fluid droplet between the imaging array and the second imaging array, through the transparent substrate and between the flat lens in the second flat lens towards the target.

10. The system of claim 3, wherein the fluid ejector comprises:
a circuitry platform comprising a fluid actuator; and
a chamber layer forming a fluid ejection chamber adjacent the fluid actuator; and
a fluid ejection orifice extending from the fluid ejection chamber to direct the fluid droplet past the imaging array past the transparent substrate and past the flat lens towards the target.

11. The system of claim 1 further comprising a target illuminator carried by the packaging.

12. The system of claim 1, wherein the fluid ejector comprises a fluid ejection orifice, the system further comprising a target support to support the target, wherein the target support spaced from the fluid ejection orifice by no greater than 10 mm.

13. An integrated fluid ejection and imaging method comprising:
concurrently aiming a fluid ejector and an imager at a deposition site, the fluid ejector and the imager being supported by a package;
ejecting a droplet of fluid from the fluid ejector onto the deposition site; and
imaging the deposition site with the imager.

14. A method for forming an integrated fluid ejection and imaging system, the method comprising:
forming a fluid ejector to eject a droplet of fluid;
forming an imager to image the droplet of fluid; and
integrating the fluid ejector and the imager as part of a package such that the fluid ejector and the imager are concurrently aimed at a deposition site.

15. The method of claim 14, wherein the forming of the fluid ejector, the forming of the imager and the integration of the fluid ejector and the imager comprises:
providing a circuitry platform comprising an imaging array and a fluid actuator;
forming a transparent substrate on the circuitry platform over the imaging array and over the fluid actuator;
forming a fluid ejection chamber opposite the fluid actuator within the transparent substrate;
forming a flat lens on the transparent substrate to focus through the transparent substrate onto the imaging array.
